(19) United States
(12) Patent Application Publication
(10) Pub. No.: US 2008/0069981 A1
(43) Pub. Date: Mar. 20, 2008

(54) Ink jet recording media coatings to improve printing properties

(75) Inventor: Yaqiang Ming, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/522,629

(22) Filed: Sep. 18, 2006

(51) Int. Cl. B41M 5/50

(52) U.S. Cl. 428/32.34

(57) ABSTRACT

The present invention relates to a composition suitable for coating an ink jet recording sheet. The composition includes a slurry of pigment particles in a liquid medium and a binder wherein the composition, as an ink-receiving formulation may provide a viscosity of about 1-10,000 centipoise. The recording sheet may then exhibit improved printing properties with respect to variables such as color richness (gamut), L*min, and visual gloss.

### FIELD OF THE INVENTION

The present disclosure relates to compositions suitable for coating ink jet recording media to optimize ink jet printing properties with respect to variables such as color richness (gamut) and L*min.

### BACKGROUND OF THE INVENTION

Ink jet printers may print in dye based ink and/or pigment based ink. While dye based ink may soak into the paper, pigment based ink may adhere to the surface of the paper. Traditionally, ink jet media have been optimized for use with dye based ink. Thus, use of pigment based ink on traditional ink jet media may provide inferior printing properties with respect to, e.g., color richness (gamut), L*min, black optical density, and ink scrape resistance. Examples of traditional ink jet media which may be optimized for use with dye based ink include Heavy Weight Matte by Kodak, a heavy weight matte coated paper based on silica gel and/or precipitated silica, and GB700P-230CD by Oji, a cast coated glossy paper based on a matte coated under layer and colloidal silica coated top layer.

Some nanoporous media have been developed for use with pigment inks. This type of media may have a resin coated paper base and multiple layers of nanoporous coating. Resin coated glossy media, however, may be expensive and may exhibit poor smear resistance and visual gloss. Several studies have been performed to improve these properties by changing ink and coating formulations. For example, acrylate dispersants may improve smear in ink sets, surfactants may improve gloss, and overcoats may be applied. It may be desired, however, to provide a relatively low cost ink jet recording media optimized for use with pigment based inks and exhibiting improved color richness (gamut), L*min, and printed visual gloss.

### SUMMARY OF THE INVENTION

In an exemplary embodiment, the present disclosure relates to a composition suitable for coating an ink jet recording sheet. The composition may include a slurry of insoluble pigment particles in a liquid medium and a polymer binder, wherein said polymer binder is dissolved in said liquid medium to provide an ink-receiving formulation having a viscosity of about 1-10,000 centipoise. The present disclosure therefore relates to such a composition which may be considered an ink-receiving formulation and to a method of producing an ink jet recording sheet incorporating such formulation as a coating layer. Accordingly, the present disclosure is also directed at a coated sheet of media including a substrate and a coating, wherein the coating includes pigment particles and a polymer binder and the media when printed on by an ink jet printer provides a gamut of greater than or equal to about 200 and L*min of less than or equal to about 15.

### BRIEF DESCRIPTION OF THE DRAWINGS

The patent or application file contains at least one drawing executed in color. Copies of this patent or patent application publication with the color drawing(s) will be provided by the U.S. Patent and Trademark Office upon request and payment of the necessary fee. The above features and other advantages of this invention and the manner of attaining them will become more apparent and the disclosure will be better understood by reference to the following description of embodiments of the invention taken in conjunction with the accompanying drawings wherein:

FIG. 1 illustrates a color file that may be used to measure gamut and L*min values.

### DETAILED DESCRIPTION

The present disclosure relates to an ink jet recording sheet optimized for use with, e.g. pigment based ink. The ink jet recording sheet may include a substrate coated with an ink-receiving formulation. The substrate may be porous and may be capable of absorbing a fluid. The substrate may be flexible and/or rigid. For example, paper of any type and any thickness may be used as a substrate and paper herein may be understood as a relatively flat material produced by the compression of fibers, wherein the fibers may be cellulosic fibers or other applicable fibers. The paper may have a matte surface (i.e. little or no coating), a luster/semi-gloss surface (i.e. coarse coating), or a glossy surface (i.e. fine coating) prior to applying the ink-receiving formulation of the present invention. Accordingly, the ink-receiving formulation of the present invention may be applied as the first layer of coating on a matte surface. The ink-receiving formulation may also be applied on top of a pre-existing coating on a glossy surface. Examples of possible paper substrates include but are not limited to X-9000 by Boise, HAMMERMILL IP RELAY MP and HAMMERMILL Laser Print, both by International Paper, HP Multipurpose and HP Advanced, both by Hewlett-Packard, and Premium Bright White by Epson. It should be appreciated, however, that the substrate may be any paper, coated or uncoated, and is not limited to the specific paper substrates set forth above. It should further be appreciated that the substrate of the present invention is not limited to paper products but contemplates any material capable of absorbing a fluid.

The substrate may have coated on at least one side thereon an ink-receiving formulation comprising one or a plurality of pigment particles and a binder. The pigment particles may be provided in dry powder form. The pigment particles may be relatively insoluble in a given medium and, thus, dispersible in that medium.

The pigment may be an inorganic pigment. The inorganic pigment may be based on an inorganic oxide having at least one inorganic element present in the oxide structure, including but not limited to aluminum oxide (e.g., fumed alumina), silicon dioxide (e.g., fumed silica), and blends thereof. It should be appreciated, however, that the pigment may include particles of precipitated silica, colloidal silica, silica gel, boehmite, pseudo-boehmite, etc. Further, the pigment may be ionic, where ionic may refer to an atom or group of atoms with a net electric charge (i.e., cationic, anionic). The pigment particles may be primary particles ranging in size from about one nanometer to about 6,000 nanometers, where expressed ranges include all values and increments therebetween. As used herein, primary particle size may refer to the size of individual solid particles as opposed to the size of agglomerates having therein a plurality of smaller sized particles.

As alluded to above, the pigment particles may be dispersed in a fluid vehicle to provide a slurry. As used herein, slurry may refer to a mixture of any liquid medium having dispersed therein particles which are relatively insoluble in that liquid medium. For example, a slurry may be a mixture of an aqueous medium (i.e., water) and water dispersible (i.e. insoluble) pigment particles. The insoluble pigment particles may provide a solid content ranging from about 10% by weight to about 55% by weight, where expressed ranges may include all values and increments therebetween. Examples of such slurries include CAB-O-SPERSE PG042 (44% by weight fumed alumina aqueous dispersion) and CAB-O-SPERSE PG008 (40% by weight fumed alumina aqueous dispersion), both of which are manufactured by Cabot. Another example is AERODISP WK 341, an aqueous dispersion of a mixed inorganic oxide (SiO₂ and Al₂O₃) having a solid content of about 41% by weight, manufactured by Degussa. Another example is SYLOJET DAZL 733C, a 30% by weight silica slurry, manufactured by Grace Davison. It should be appreciated that the pigment particles may be pre-dispersed in the liquid medium. It should further be appreciated that the pigment particles and liquid medium may be provided as two separate components, rather than as a pre-dispersed slurry, such that the particles and medium may be mixed at a later time in the production process.

With respect to the binder in the ink-receiving formulation, binder may refer to any polymer that is soluble in the liquid medium in which the pigment particles may be dispersed. It should therefore be appreciated that different polymer binders may be used with different liquid mediums to provide a polymer binder which is soluble in the given liquid medium. Polymers may be soluble in a given liquid medium (i.e., solvent system) when the polymer-solvent interactions are stronger than the polymer-polymer attraction forces, thereby causing the polymer chains to absorb solvent molecules. For example, in the exemplary embodiment in which water is the solvent, polar macromolecules such as polyacrylic acid, polyacrylamide, polyvinyl alcohol, polyvinyl pyrrolidone, cellulose, and copolymers and blends thereof may be soluble in the water solvent. It should therefore be appreciated that any polymer having polar side group functionality, including but not limited to carboxylic acid functionality (—COOH), amide functionality (—CONH₂), and hydroxyl functionality (—OH), may be soluble in a liquid medium of water. One example of an available binder may be MOWIOL 26-88, a polyvinyl alcohol (PVOH) manufactured by Kuraray.

The binder may provide for adhesion of the pigment particles to the surface of the substrate and reduce removal of the pigment particles by mechanical abrasion. The binder may thus be compatible with the pigment and may exert binding strength on the pigment. On relatively rough substrates, it may be desired to use a small amount of binder to reduce viscosity. A ratio of pigment to binder may vary depending on binder type and molecular weight. For example, the pigment to binder ratio may range from about 1:1 to about 50:1, where expressed ranges may include all values and increments therebetween. It should be appreciated that, upon combining the pigment particles, liquid medium, and binder, the insoluble pigment particles may continue to provide a solid content ranging from about 10% by weight to about 55% by weight, where expressed ranges may include all values and increments therebetween. For example, the solid content may be in the range of about 15%-50% by weight, or 25%-45% by weight, etc.

Optionally, the ink-receiving coating may further comprise additives. Additives may include but are not limited to viscosity modifying compounds (i.e., thickening agents), surfactants (i.e., wetting agents), crosslinking agents, buffering agents, biocides, defoamers, and mixtures thereof. As used herein, a viscosity modifying compound may refer to any compound that may be added to a mixture to increase or decrease the viscosity of the mixture without substantially affecting other properties of the mixture. As used herein, a surfactant may refer to any compound that may lower surface tension of a liquid and/or lower interfacial tension between two immiscible substances. As used herein, a crosslinking agent may refer to any compound that induces the formation of covalent bonds between polymer chains. As used herein, a buffering agent may refer to any compound that may adjust and/or maintain the pH of a solution. As used herein, a biocide may refer to any compound that may kill or slow growth of some forms of living organisms, e.g., an antimicrobial to inhibit bacterial activity. As used herein, a defoamer may refer to any compound that may remove or prevent formation of bubbles of air or gas in a matrix of liquid due to agitation.

The binder, pigment particles, and liquid medium may be combined in any method and order to provide an ink-receiving formulation that may have a continuous phase of a polymer binder dissolved in a liquid medium and a dispersed phase of insoluble pigment particles. For example, the pigment particles may be dispersed in a liquid medium to provide a slurry, and then the polymer binder may be dissolved in the slurry. As another example, the polymer binder may be dissolved in a liquid medium, and then pigment particles may be dispersed in the liquid medium. In yet another example, the polymer binder may be combined with the pigment particles and then mixed in a liquid medium to dissolve the binder and disperse the pigment particles.

The viscosity of the ink-receiving formulation may be optimized to provide a relatively uniform coating on the substrate. The optimal viscosity may depend on the coating process used to apply the ink-receiving formulation to the substrate. For example, any coating manufacturing procedure may be used to apply the ink-receiving formulation to the substrate, including but not limited to roll coating, spray coating, immersion coating, cast coating, slot die coating, curtain coating, rod coating, blade coating, roller application, and combinations and derivations thereof. Accordingly, the viscosity of the ink-receiving formulation may be varied to complement a given coating process. Variables such as solid content and pigment to binder ratio may be selectively varied within particular ranges to optimize the viscosity for a given coating process. For example, and as alluded to above, the solid content of the insoluble pigment particles may range from about 10% to about 55% by weight, and the pigment to binder ratio may range from about 1:1 to about 50:1, where expressed ranges may include all values and increments therebetween. Thus, and depending on the coating process, the viscosity of the ink-receiving formulation may range from about 1 centipoise to about 10,000 centipoise, where expressed ranges include all values and increments therebetween. For example, the viscosity may range between 50-5000 centipoise, or 20-2000 centipoise, etc.

Further, optimizing viscosity to complement a given coating process may provide for improvements in the coating process and, therefore, the final coated product. For example, a high solid content formulation, which may be a variable in optimizing viscosity, may allow the coating process to be run at high speed. As another example, an optimized viscosity may allow for improved control over the weight of the coating applied to the substrate. A coat weight of about 1 g/m² to about 50 g/m² may be applied per surface, where expressed ranges may include all values and increments therebetween. For example, in the exemplary embodiment in which the substrate is normal plain paper, the coat weight may range from about 1 g/m² to about 15 g/m² per surface, or 4-15 g/m², etc. It should be appreciated, however, that coat weight may vary depending on the substrate used. For example, coat weight may be high enough to cover the surface voids of a given substrate to provide acceptable printing properties. However, although high coat weight may offer some performance improvement, it may also disproportionately increase material cost and/or generate defects such as crack. Thus, coat weight may be low enough to provide a cost-effective, substantially crack-free coating. However, low coat weight may leave some substrate surface voids exposed and result in poor printing properties. It should therefore be appreciated that while coat weight may be higher or lower depending on a given substrate, coat weight may be controlled by first optimizing the viscosity of the ink-receiving formulation.

During the coating process, one or both surfaces of the substrate may be coated with the ink-receiving formulation. A single process may be used to apply the ink-receiving formulation to both surfaces of the substrate. Where only one surface is coated with the ink-receiving formulation, the other surface may be coated with an anti-curling or anti-cockling (i.e. anti-wrinkle) layer. Optionally, colloidal silica may be coated on top of the ink-receiving formulation to provide a gloss improvement or antiscratch layer. The colloidal silica may be applied via a single or two-step process.

The coating may be dried by exposure to air during and/or after the coating process. This technique may be particularly effective where running speed is relatively low, but may also be used at relatively higher running speeds. Additional drying methods may include but are not limited to exposure to infrared radiation and/or heating in a convection oven.

The resulting product, a relatively low cost ink jet recording sheet comprised of a substrate having coated thereon an ink-receiving formulation, may provide a surface optimized for interaction with pigment based inks. Accordingly, images printed on the presently disclosed coating in pigment based inks may provide enhanced color richness (gamut), L*min, and visual gloss of a printed surface. As used herein, color richness (gamut) may refer to the portion of visible color space that may be reproduced by a given output device (e.g., color printer) and/or represented within a given printed image. As used herein, L*min may refer to a measure of the minimum lightness (i.e., darkness) provided by a set of colorants. As used herein, visual gloss may refer to a measure of shininess and/or luster of a surface as perceived by the unaided human eye at various angles under normal lighting conditions.

The enhanced color richness (gamut), L*min, and visual gloss may also apply herein to images printed on the present coatings using dye based inks. It should therefore be appreciated that the ink jet recording sheet of the present invention may provide for improved printing properties of both pigment and/or dye based inks.

The disclosure may be further illustrated by the following examples. It should be understood that the following examples are not intended to limit the scope of this invention.

### EXAMPLE 1

Five exemplary ink-receiving formulations were prepared according to Table 1 to illustrate the present invention. It should be appreciated that the present invention is not limited to the particular features of the five exemplary formulations set forth in Table 1.

Pigment, binder, and deionized water values are in parts per hundred and based on weight. Ratios are also based on weight. Further, all percentages are by weight.

TABLE 1
Exemplary Coating Formulations to Illustrate the Present Invention

| | | Formulation Identifying Number | | | | |
|---|---|---|---|---|---|---|
| | | 1 | 2 | 3 | 4 | 5 |
| Pigment | 44% fumed alumina aqueous dispersion | 85.11 | — | — | 41.24 | 63.04 |
| | (particle size about 150 nm) | | | | | |
| | 40% fumed alumina aqueous dispersion | — | 86.20 | — | — | — |
| | (particle size about 150 nm) | | | | | |
| | 41% mixed inorganic oxide | — | — | 83.40 | 44.25 | — |
| | (about 99.5% SiO₂ content and | | | | | |
| | about 0.05–0.5% Al₂O₃ content) | | | | | |
| | aqueous dispersion | | | | | |
| | (particle size about 140 nm) | | | | | |
| | 30% silica slurry | — | — | — | — | 23.11 |
| | (particle size about 300 nm) | | | | | |
| Binder | Polyvinyl alcohol (10 wt. %) | 14.89 | 13.80 | 13.65 | 14.51 | 13.85 |

| | | | | | |
|---|---|---|---|---|---|
| Deionized Water | — | — | 2.95 | — | — |
| Pigment to Binder Ratio | 25/1 | 25/1 | 25/1 | 25/1 | 25/1 |
| Alumina to Silica Ratio | — | — | — | 50/50 | 80/20 |
| Solid Content of Formulation (%) | 38.9 | 35.9 | 35.5 | 37.7 | 36.0 |

### EXAMPLE 2

The effect of Formulation 1 on several commercially available plain paper substrates was examined. The ink-receiving formulation was applied to six plain paper substrates using a #7 Meyer rod to provide a coat weight of about 8 g/m². The coating was air dried. The coated sheets were printed by a Husky printer with Yosemite color and mono inks (YOC/YOM) at plain/normal printing mode with a standard plain paper gamut file. The gamut and L*min were measured and are given in Table 2.

For comparative example, six plain paper substrates were printed by a Husky printer with Yosemite color and mono inks (YOC/YOM) at plain/normal printing mode with a standard plain paper gamut file. The gamut and L*min were measured and are given in Table 2.

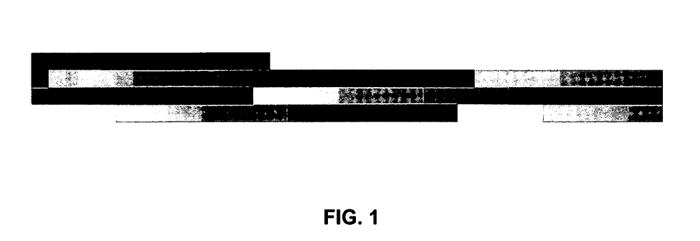

As can be seen, improved gamut and L*min was identified as compared to the comparative examples. The images of the present invention are also glossier in appearance (visual gloss). It should be noted that the gamut and L*min are determined herein and in all of the ensuing examples after printing the color file in FIG. 1 via an ink jet printer at a given printing mode for a given substrate and allowing to dry overnight. An X-RiteColor Spectrofiler is then used to measure gamut and L*min values relative to such color file. For paper comparisons, all ink cartridges, printing modes and measurement conditions are kept constant.

TABLE 2
Effect of Formulation 1 on Gamut and L * min
of Various Plain Paper Substrates

| Substrate | Coating | Gamut | L * min |
|---|---|---|---|
| X-9000 | Formulation 1 | 303 | 12.86 |
| (by Boise) | Comparative Example | 115 | 22 |
| HAMMERMILL IP | Formulation 1 | 281 | 14.03 |
| RELAY MP | Comparative Example | 132 | 17.76 |
| (by International Paper) | | | |
| HP Multipurpose | Formulation 1 | 305 | 13.2 |
| (by Hewlett-Packard) | Comparative Example | 119 | 21.83 |
| HP Advanced | Formulation 1 | 293 | 12.48 |
| (by Hewlett-Packard) | Comparative Example | 161 | 18 |
| HAMMERMILL Laser Print | Formulation 1 | 346 | 12.5 |
| (by International Paper) | Comparative Example | 169 | 18.67 |
| Premium Bright White | Formulation 1 | 277 | 13.7 |
| (by Epson) | Comparative Example | 199 | 19 |

### EXAMPLE 3

The effect of Formulations 1-5 on a plain paper substrate was examined and compared to commercial matte and cast coated glossy media.

Formulations 1-5 were applied to a plain paper substrate using a #7 Meyer rod to provide a coat weight of about 8 g/m². The coating was air dried. The coated sheets were printed by a Husky printer with Yosemite color and mono inks (YOC/YOM) at plain/normal printing mode with a standard plain paper gamut file. The gamut and L*min were measured and are given in Table 3.

For comparative example, commercial matte and cast coated glossy media were printed by a Husky printer with Yosemite color and mono inks (YOC/YOM) at plain/normal printing mode with a standard plain paper gamut file. The gamut and L*min were measured and are given in Table 3.

As can be seen, with respect to all five formulations on plain paper substrates, there is an improved gamut and L*min as compared to the comparative example X-9000 plain paper substrate by Boise of Example 2. As compared to commercial matte media, the present invention provides improved gamut and L*min. Further, an improved gamut and approximately equal L*min have been identified as compared to commercial cast coated media. The images of the present invention are also glossier in appearance (visual gloss).

TABLE 3
Effect of Formulations 1–5 on Gamut and L * min
Compared to Matte and Cast Coated Glossy Media

| Substrate | Coating | Gamut | L * min |
|---|---|---|---|
| X-9000 Plain | Formulation 1 | 303 | 12.86 |
| (by Boise) | Formulation 2 | 291 | 15.6 |
| | Formulation 3 | 286 | 13.1 |
| | Formulation 4 | 299 | 11.3 |
| | Formulation 5 | 291 | 11.9 |
| Heavy Weight Matte | Comparative Example | 216 | 17.4 |
| (by Kodak) | | | |
| IJM 113 Matte (by Océ) | Comparative Example | 215 | 16.5 |
| GB700P-230CD Cast | Comparative Example | 280 | 13.8 |
| Coated Glossy (by Oji) | | | |

### EXAMPLE 4

A plain paper substrate coated with Formulation 1 was compared to commercially available plain paper, matte paper, cast coated glossy paper, and resin coated glossy paper using a different photo mode and gamut file than the previous examples.

Formulation 1 was applied to a plain paper substrate using a #7 Meyer rod to provide a coat weight of about 8 g/m². The coating was air dried. The coated sheets were printed by a Husky printer with Yosemite color and mono inks (YOC/YOM) at photo glossy/4800 dpi mode with a standard photo paper multipurpose gamut file. The gamut and L*min were measured and are given in Table 4.

For comparative example, commercial plain paper, matte paper, cast coated glossy paper, and resin coated glossy paper were printed by a Husky printer with Yosemite color and mono inks (YOC/YOM) at photo glossy/4800 dpi mode with a standard photo paper multipurpose gamut file. The gamut and L*min were measured and are given in Table 4.

As can be observed an improved gamut and L*min are identified as compared to the commercial plain paper, matte paper, and cast coated glossy paper. With respect to resin coated glossy paper, the present formulations do not provide the same type of improvements to gamut and L*min. It should be appreciated, however, that resin coated glossy media such as microporous glossy paper can be relatively expensive.

TABLE 4
Comparison of Formulation 1 with Commercial Media
Using Photo Mode

| Substrate | Coating | Gamut | L * min |
|---|---|---|---|
| HAMMERMILL Laser | Formulation 1 | 392 | 10 |
| Print Plain | Comparative Example | 181 | 25.9 |
| (by International Paper) | | | |
| Heavy Weight Matte | Comparative Example | 198 | 31.6 |
| (by Kodak) | | | |
| GB700P-230CD Cast | Comparative Example | 354 | 11.1 |
| Coated Glossy (by Oji) | | | |
| Microporous Resin | Comparative Example | 463 | 5.3 |
| Coated Glossy Paper | | | |

### EXAMPLE 5

A plain paper substrate coated with formulation 1 was compared to commercially available plain paper and various media by Epson using a pigment system by Epson.

Formulation 1 was applied to one brand of paper substrate using a #7 Meyer rod to provide a coat weight of about 8 g/m². The coating was air dried. The coated sheets were printed by an EPSON STYLUS CX7800 pigment printer with DURABRITE inks by Epson at heavyweight matte/photo printing mode with a standard photo paper multipurpose gamut file. The gamut and L*min were measured and are given in Table 5.

For comparative example, commercial plain paper was printed by an EPSON STYLUS CX7800 pigment printer with DURABRITE inks by Epson at Plain or Epson Premium Bright White/Text & Image printing mode with a standard plain paper gamut file. Further, three types of Epson papers (plain, matte, and resin coated glossy) were printed by an EPSON STYLUS CX7800 pigment printer with DURABRITE inks by Epson at various printing modes. Gamut strips for photo and plain paper gamut file were used. The gamut and L*min were measured and are given in Table 5.

The present invention provides improved gamut and L*min as compared to all comparative examples except for the resin coated glossy media. With respect to the resin coated glossy media, the present invention provides improved L*min but does not provide improved gamut. As alluded to above, it should be appreciated that resin coated glossy media can be much more expensive.

TABLE 5
Comparison of Formulation 1 with Plain Paper and Various Media
by Epson Using a Pigment System by Epson

| Substrate | Coating | Printing Mode | Gamut | L * min |
|---|---|---|---|---|
| HAMMERMILL Laser Print | Formulation 1 | Heavyweight Matte/Photo | 416 | 8.4 |
| Plain (by International | Comparative Example | Plain or Epson Premium Bright | 164 | 25.2 |
| Paper) | | White/Text & Image | | |
| Premium Bright White | Comparative Example | Plain or Epson Premium Bright | 198 | 31.6 |
| Plain (by Epson) | | White/Text & Image | | |
| Heavyweight Matte | Comparative Example | Heavyweight Matte/Photo | 310 | 16.3 |
| (by Epson) | | | | |
| Premium Resin Coated | Comparative Example | Epson Premium Glossy/Best | 430 | 10.6 |
| Glossy (by Epson) | | Photo | | |

### EXAMPLE 6

A plain paper substrate coated with formulation 1 was compared to plain, matte, cast coated glossy, and resin coated glossy media using a dye based ink system.

Formulation 1 was applied to a plain paper substrate using a #7 Meyer rod. The present invention and all comparative examples in Table 6 were printed by a LEXMARK P6250 printer by Lexmark with 33(dye)/34 (black pigment) cartridges using at least two of three modes: plain/normal, coated/normal, and/or photo/glossy. The standard multipurpose image with gamut strips for photo and plain paper gamut file were used. The gamut and L*min were measured and are given in Table 6.

The present invention provides improved gamut and L*min as compared to the plain and matte paper comparative examples. With respect to the cast coated glossy paper, the gamut of the present invention is improved in a plain/normal mode, and the L*min of the present invention is improved in both the plain/normal and coated/normal modes. With respect to the resin coated glossy media, the present invention did not provide the same improvement to gamut or L*min. As alluded to above, it should be appreciated that resin coated glossy media can be much more expensive.

TABLE 6
Comparison of Formulation 1 with Various Substrates
Using a Dye Based Ink System

| Substrate | Coating | Printing Mode | Gamut | L * min |
|---|---|---|---|---|
| HAMMERMILL Laser Print Plain | Formulation 1 | Plain/Normal | 286 | 20.4 |
| (by International Paper) | | Coated/Normal | 321 | 15.7 |
| | | Photo/Glossy | 411 | 17.4 |
| | Comparative Example | Plain/Normal | 141 | 31.1 |
| | | Photo/Glossy | 183 | 38.3 |
| Heavy Weight Matte | Comparative Example | Plain/Normal | 256 | 24.3 |
| (by Kodak) | | Coated/Normal | 277 | 20.2 |
| | | Photo/Glossy | 333 | 20.3 |
| GB700P-230CD Cast Coated | Comparative Example | Plain/Normal | 251 | 24.5 |
| Glossy (by Oji) | | Coated/Normal | 341 | 18 |
| | | Photo/Glossy | 467 | 6.6 |
| Microporous Resin Coated Glossy | Comparative Example | Plain/Normal | 326 | 13.4 |
| Paper | | Coated/Normal | 412 | 10.9 |
| | | Photo/Glossy | 540 | 7.5 |

### EXAMPLE 7

The preprint and post print gloss of Formulation 1 on plain paper was compared with that of plain, matte, cast coated glossy, and resin coated glossy media.

The present invention and all comparative examples in Table 7 were printed by a Husky printer with Yosemite color and mono inks (YOC/YOM). The printing file was standard 40 block gloss file. The printing mode was plain/normal. The gamut and L*min were measured and are given in Table 7.

The present invention provided improved measured gloss than the plain and matt coated papers. The improved visual gloss is even more significant.

TABLE 7
Preprint and Post Print Measured Gloss
of Formulation 1 Coated Paper Compared with Other Media

| | | | | Postprint Gloss | | | |
|---|---|---|---|---|---|---|---|
| | | Preprint | | | 20° | | 60° |
| | | Gloss | | | Differential | | Differential |
| Substrate | Coating | 20° | 60° | 20° | Gloss (%) | 60° | Gloss (%) |
| HAMMERMILL Laser Print | Formulation 1 | 1.96 | 10.23 | 1.86 | 23 | 11.77 | 26 |
| Plain (by International | Comparative | 1.37 | 4.39 | 0.78 | 39 | 3.13 | 23 |
| Paper) | Example | | | | | | |
| Heavy Weight Matte | Comparative | 1.19 | 2.62 | 0.74 | 42 | 1.67 | 34 |
| (by Kodak) | Example | | | | | | |
| Resin Coated Glossy | Comparative | 34.67 | 60.45 | 34.03 | 25 | 67.64 | 18 |
| Paper | Example | | | | | | |
| Resin Coated Glossy | Comparative | 36.69 | 56.83 | 43.01 | 26 | 72.97 | 20 |
| Paper | Example | | | | | | |

As can therefore be seen from the above, the present disclosure provides a coated sheet of media including a substrate and a coating, wherein the coating includes pigment particles and a polymer binder and the media when printed on by an ink jet printer provides a gamut of greater than or equal to about 200 and L*min of less than or equal to about 15. The value of gamut may also range between about 200-600 and the value of L*min may range between about 5-15. Such values of gamut and L*min are particularly realized utilizing the formulations herein, with the indicated control of the type and concentration of ingredients (e.g. pigment particles, binder, etc.) as applied to an ink jet printed sheet of media, such as plain paper which may be porous and wherein such ink jet may rely upon either pigment or dye based ink formulations.

A number of implementations have been described. Nevertheless, it will be understood that various modifications may be made. Accordingly, other implementations are within the scope of the following claims.

What is claimed is:

1. A composition suitable for coating an ink jet recording sheet, said composition comprising:
a slurry of insoluble pigment particles in a liquid medium; and
a polymer binder, wherein said polymer binder is dissolved in said liquid medium to provide an ink-receiving formulation having a viscosity of about 1-10,000 centipoise.

2. The composition of claim 1 wherein said viscosity is about 50-5000 centipoise.

3. The composition of claim 1 wherein said slurry has a solids content of about 10-55%.

4. The composition of claim 1 wherein said ink-receiving formulation has a solid content of about 10-55%.

5. The composition of claim 1 wherein said insoluble pigment particles are ionic.

6. The composition of claim 1 wherein said insoluble pigment particles are inorganic oxides containing aluminum, silicon, or mixtures thereof.

7. The composition of claim 1 wherein said insoluble pigment particles have a particle size of about 1-6,000 nanometers.

8. The composition of claim 1 wherein said liquid medium is water.

9. The composition of claim 1 wherein said polymer binder is selected from the group consisting of polyacrylic acid, polyacrylamide, polyvinyl alcohol, polyvinyl pyrrolidone, cellulose, and copolymers and blends thereof.

10. The composition of claim 1 wherein said ink-receiving formulation has a pigment to binder ratio ranging from about 1:1 to about 50:1.

11. The composition of claim 1 further comprising additives selected from the group consisting of viscosity modifying compounds, surfactants, crosslinking agents, buffering agents, biocides, defoamers, and mixtures thereof.

12. A method of forming a composition suitable for coating an ink jet recording sheet substrate including insoluble pigment particles, a polymer binder and a liquid medium, comprising:
dispersing said insoluble pigment particles in said liquid medium; and
dissolving said polymer binder in said liquid medium and forming an ink-receiving formulation having a viscosity of about 1-10,000 centipoise.

13. The method of claim 12 further comprising:
coating at least one surface of said substrate with said ink-receiving formulation; and
drying said ink-receiving formulation on said substrate.

14. The method of claim 13 wherein said substrate, when printed on by an ink jet printer, provides a gamut of greater than or equal to 200 and L*min of less than or equal to about 15.

15. The method of claim 13 wherein said ink-receiving formulation is applied to said substrate at a coat weight of about 1-50 g/m².

16. The method of claim 13 wherein said ink-receiving formulation is coated on said substrate by roll coating, spray coating, immersion coating, cast coating, slot die coating, curtain coating, rod coating, blade coating, roller application, or combinations thereof.

17. The method of claim 13 wherein said ink-receiving formulation is dried on said substrate by infrared radiation, convection oven heating, exposure to air, or combinations thereof.

18. The method of claim 13 further comprising coating an uncoated surface of said substrate with an anti-curling and/or anti-cockling coating.

19. The method of claim 13 further comprising applying a layer of colloidal silica.

20. A coated sheet of media comprising:
a substrate and a coating, said coating comprising pigment particles and a polymer binder and wherein said media when printed on by an ink jet printer provides a gamut of greater than or equal to about 200 and L*min of less than or equal to about 15.

21. The coated sheet of media of claim 20 wherein said value of gamut is about 200-600.

22. The coated sheet of media of claim 20 wherein said value of L*min is about 5-15.

23. The coated sheet of media of claim 20 wherein said coating is present at a coat weight of about 1-50 g/m².

24. The coated sheet of media of claim 20 wherein said media when printed on by an ink jet printer providing a pigment based ink provides a gamut of greater than or equal to about 200 and L*min of less than or equal to about 15.

25. The sheet of media of claim 20 wherein said substrate comprises paper.
